(19) United States
(12) Patent Application Publication
(10) Pub. No.: US 2003/0055540 A1
(43) Pub. Date: Mar. 20, 2003

(54) Anti-terrorism aircraft flight control system

(76) Inventor: James K. Hansen, Fairfax, VA (US)

Correspondence Address: James K. Hansen, 4094 Majestic Lane, #153, Fairfax, VA, 22033, US

(21) Appl. No.: 09/956,217

(22) Filed: Sep. 20, 2001

(51) Int. Cl. G06F 17/00

(52) U.S. Cl. 701/3; 701/14; 701/11

(57) ABSTRACT

The invention disclosed herein is a computerized control system for aircraft which will prevent catastrophic damage and loss of life associated with terrorists hijacking large aircraft and using them as flying bombs to destroy buildings, military bases and government installations, and to kill people. The system works stand-alone or with existing aircraft equipment to monitor aircraft position, velocity, and acceleration and give warnings to the pilot and to authorities when an aircraft enters a prohibited airspace. The system further incorporates an override system which will take control of an aircraft which has entered or is about to enter a designated prohibited three-dimensional area. It also includes a code-entered override, which can be transmitted to the pilot via radio, in the event that the aircraft is damaged and must land in a prohibited area such as at a military base.

### CROSS-REFERENCE TO RELATED APPLICATIONS

Not Applicable

### STATEMENT REGARDING FEDERALLY SPONSORED R & D

Not Applicable

### REFERENCE TO A MICROFICHE APPENDIX

Not Applicable

### BACKGROUND OF THE INVENTION

The current invention is a computerized aircraft flight control system which monitors position, velocity and acceleration of aircraft in flight relative to known prohibited flying areas and actively pilots aircraft which have entered prohibited flying areas. It falls under U.S. Patent Class 244/75R, devices and arrangements directed to and limited to the controlling of an aircraft in flight.

On Sep. 11, 2001 the United States was forever changed. A group of terrorists simultaneously hijacked four American commercial jet liners and piloted three of them into the World Trade Center's Twin Towers and The Pentagon, causing loss of thousands of lives, billions of dollars in damages, and a crippled economy. These horrible acts committed by these suicide bombers could have been prevented.

The invention disclosed herein offers a permanent solution to the vulnerability of commercial aircraft and the vulnerability of structures on the ground, including cities, governmental buildings, bridges, and military bases, and the people inside those structures. The invention is a computerized control system for aircraft which will prevent catastrophic damage and loss of life associated with terrorists hijacking large aircraft and using them as flying bombs. The system, installed on aircraft, uses global positioning sensors or similar equipment to monitor aircraft position, velocity, and acceleration and give warnings to the pilot and to authorities when an aircraft enters or is about to enter a prohibited airspace. The system further incorporates an override system which will take control of an off-course aircraft which has entered or is about to enter a designated prohibited three-dimensional area. The system contains a computerized database of 3-D no-fly zones, which can be updated real-time to include emergency conditions on the ground (radiation hazard, poisonous gas leak, etc.) and current storms. It also includes provisions for a code-entered manual override, which can be transmitted to the pilot via radio, in the event that the aircraft is damaged and must land in a prohibited area such as at a military base. This code may be released by an air-traffic controller who makes a decision based on available evidence. If for instance, the pilot had set its transponder to the hijack signal a short time before he reported engine failure, the air traffic controller may decide to not let that aircraft land at a sensitive military base but direct it elsewhere.

The only known examples of prior art are U.S. Pat. No. 6,173,219 (Deker) and U.S. Pat. No. 6,161,063 (Deker), which both detail methods for optimizing a flight plan around an object such as a storm, by simulating simple polygonal shapes and choosing either the right path or the left path around those objects. These patents would not prevent a pilot from actually flying into the “avoidance zones”, but merely plot a safe route around these zones. The invention disclosed herein, would not only monitor the aircraft continuously, but warn pilots and authorities if an air-space breach is possible. It will also take control of the aircraft if need be, and pilot it away from the no-fly zone automatically, to a safer area or possibly over water. This will prevent terrorists from hijacking aircraft and using them as flying bombs destroying cities and killing innocent people.

### BRIEF SUMMARY OF THE INVENTION

The current invention is a computerized control system for aircraft which will prevent catastrophic damage and loss of life associated with terrorists hijacking large aircraft and using them as flying bombs to destroy buildings, military bases and government installations, and to kill people. The system works stand-alone or with existing aircraft equipment to monitor aircraft position, velocity, and acceleration and give warnings to the pilot and to authorities when an aircraft enters a prohibited airspace. The system further incorporates an override system which will take control of an aircraft which has entered or is about to enter a designated prohibited three-dimensional area. It also includes a code-entered override, which can be transmitted to the pilot via radio, in the event that the aircraft is damaged and must land in a prohibited area such as at a military base.

This invention differs greatly from prior art (Deker), in that it actively will control the aircraft away from no-fly zones, and work in conjunction with air traffic controllers to ensure safety within the no-fly zone. It also will continuously calculate possible breaches in no-fly zones, and record all data pertaining to these breaches for investigation. This invention will also keep aircraft from veering off-course when approaching runways while landing. This will protect buildings and sensitive areas immediately around airports as well.

### BRIEF DESCRIPTION OF THE SEVERAL VIEWS OF THE DRAWING

FIG. 1 is a plan view of an aircraft incorporating the invention.

FIG. 2 is a plan view of an aircraft incorporating the invention as it approaches a prohibited flying area.

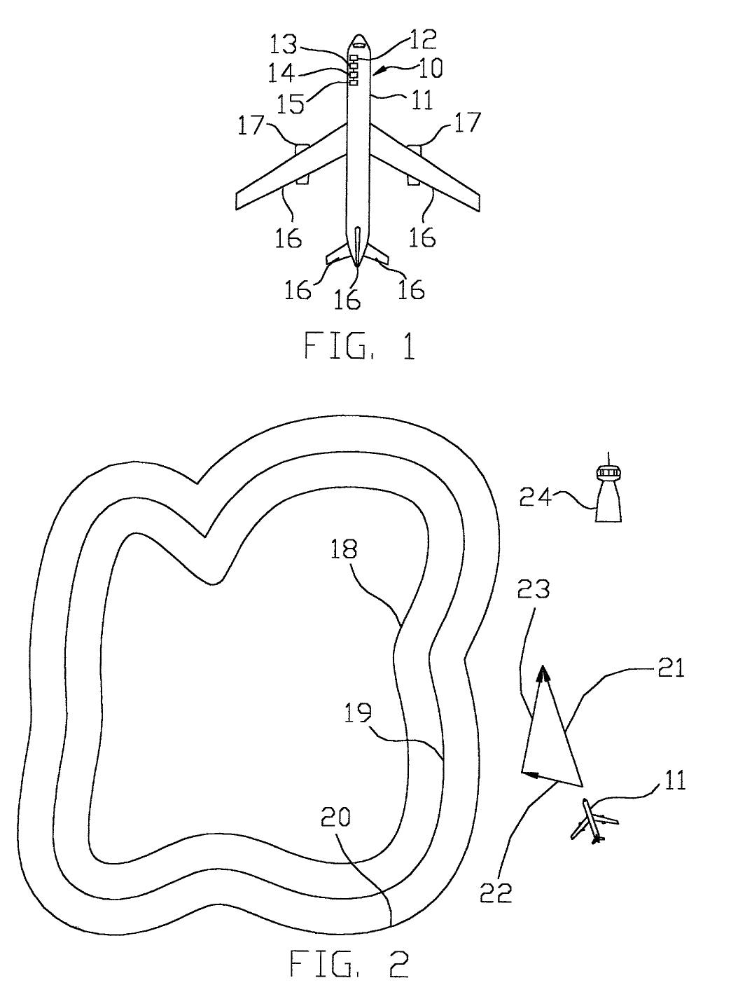

### DETAILED DESCRIPTION OF THE INVENTION

The detailed description of the present invention is enclosed herein; however, it is to be understood that the disclosed description is merely exemplary of the invention, which may be embodied in various forms. Therefore, these details are not to be interpreted as limited, but as a basis for the claims and as a basis for teaching one skilled in the art how to make and use the invention.

The present invention consists of a computerized control system for an aircraft comprising: a computerized database of complex three-dimensional areas defining cities, buildings, military bases, bridges and other structures and areas which must be avoided during aircraft flight; a global positioning sensor providing said control system with position, velocity, and acceleration data of said aircraft; a notification system to alert the pilot as well as proper authorities of a breach in a prohibited flying area; and an override control computer and flight control software to automatically pilot said aircraft safely away from the prohibited flying area in the event of an airspace violation. Within the no-fly zone database, there may exist one or more areas immediately surrounding the no-fly zones, which will provide early warning that a breach is possible. This invention can use much of the current equipment aboard commercial jets including transponders, global positioning systems, autopilot systems, and radios. The control system can be incorporated into a single computer which can be made modularly to be updatable with faster computers as technology advances, increasing the speed of calculating possible breaches. The system should be installed on aircraft in an undisclosed location, safely out of reach of hijackers, who may attempt to tamper with it.

The invention also incorporates a manual override function which would allow a pilot to enter a designated prohibited area if the aircraft were damaged and needed to perform an emergency landing. This might include a military base or large highway. One embodiment of the invention further includes measures requiring third party (i.e. air traffic controller) approval, before it could enter a prohibited airspace. If, for instance, the aircraft had set its transponder to the hijack signal several minutes before the pilot reported engine failure, the air traffic controller may choose to not allow this breach for safety reasons, and require the aircraft to travel to a rural area to attempt a landing, or wait for a fighter jet escort.

Referring to the drawings, the control system 10, is mounted on the aircraft 11 in a tamper-resistant place, and is comprised of a computerized database of prohibited flying areas 12, the global positioning sensor 13, the breach notification system 14, and the override control computer 15. Aircraft navigational systems 16, include flaps, ailerons, rudders, elevators, etc., while power systems 17, encompass the aircrafrs engines. Referring to FIG. 2, the border of the prohibited flying area 18 (shown in two dimensions for clarity) is surrounded by a secondary prohibited flying area 19 as well as a buffer zone 20, which would give early warning to pilots and authorities on the ground of a possible breach. If there were a buffer zone violation, the pilot would have to immediately correct and exit the buffer zone safely as soon as possible. If the pilot were to continue into the buffer zone, toward a portion of the no-fly zone, the anti-terrorist override computer would engage and fly the aircraft safely away from the zone. It may further, depending on available fuel and air traffic controller discretion, either pilot the aircraft a safe distance from any no-fly zones and remain there circling (possibly giving passengers or air marshals a chance to overtake the hijackers or suicidal pilots), or relinquish control back to the pilots to land the aircraft in a safer area, or wait for fighter jet escort. The system can also invoke a recorded message to passengers via the intercom that the aircraft is not under the control of a qualified pilot, and has attempted to enter prohibited air space; this, too, at the discretion of air traffic controllers or other authorities.

Referring again to FIG. 2, the arrow depicting the aircraft's velocity 21, is shown vectorially as the sum of the velocity component perpendicular 22 to the nearest point of the no-fly zone and the velocity component parallel 23 to the nearest point of the no-fly zone. The perpendicular component 22 of the velocity vector will determine the likelihood of a possible breach and will with other factors be the basis for calculating such a likelihood. The third party, which may intervene is located within the control tower 24. In the event of a breach or possible breach, the nearest control tower would be notified immediately, and the air traffic controller could direct other aircrafts in the area away for safety reasons.

The invention can be installed on a trial basis without the knowledge of pilots if need be, and the database of prohibited areas can also be kept confidential. All actions aboard the aircraft can be recorded for later investigation, and can be downloaded to authorities real-time while the aircraft is in the air via radio or satellite transmission, eliminating the need for out-dated, protective “black boxes” in the event of a crash.

The invention can also prevent pilots from plummeting their aircraft into non-sensitive areas, like the ocean (e.g. Egypt Air crash). By monitoring the aircraft's systems and position, velocity and acceleration data, the control system can stop a pilot from intentionally nose-diving an aircraft. The override control computer would detect unsafe maneuvers, and take control of the aircraft if need be, allowing the aircraft to proceed safely until the terrorist can be apprehended and the other pilot or another person can take the controls.

Although a certain preferred embodiment has been disclosed , it is in no way intended to limit the invention or the protection afforded by the claims.

I claim:

1. A tamper-proof, computerized control system for an aircraft comprising:
a. a computerized, updatable database of three-dimensional prohibited flying areas;
b. a global positioning sensor or similar device providing said control system with position, velocity, and acceleration data of said aircraft;
c. a notification system to alert proper authorities of a breach in said prohibited flying areas or unsafe flying maneuvers and to download current flight data while said aircraft is in the air via radio, satellite, or similar transmission;
d. and an override control computer and flight control software to calculate possible breaches in said prohibited areas, monitor for unsafe flying maneuvers, automatically pilot said aircraft away from said prohibited flying area in the event of an airspace violation or possible airspace violation, and take control of said aircraft if undergoing erratic or unsafe flight maneuvers.

2. The control system of claim 1, wherein immediately surrounding said prohibited flying areas, there exists one or more secondary prohibited flying areas giving early warning notices to pilots and governing bodies about a possible breach.

3. The control system of claim 1, wherein said override control computer and said flight control software use an existing autopilot feature on said aircraft to navigate said aircraft away from said prohibited areas or resume safe flight after erratic flying maneuvers.

4. The control system of claim 1, wherein said global positioning sensor or similar device utilizes existing sensors on said aircraft to obtain or verify position, velocity, and acceleration data.

5. The control system of claim 1, wherein said notification system uses an existing transponder or similar transmitting device on said aircraft to notify authorities of a breach in said prohibited flying areas.

6. The control system of claim 1, wherein said override control computer monitors said aircraft's navigational and power systems ensuring full functionality and allows breach of certain predetermined prohibited areas if certain navigational systems fail.

7. The control system of claim 6, wherein, in the event of a navigational or power system failure, a pilot would receive a code from a governing body, which, when properly entered, would allow said pilot to navigate said aircraft into a prohibited area to land said aircraft.

8. The control system of claim 1, wherein said flight control software calculates said aircraft's velocity component perpendicular to the nearest prohibited area and provides safe warning to a pilot that there exists a danger of penetration of said prohibited flying area if a navigational correction is not immediately employed.

9. The control system of claim 8, wherein said override control computer and said flight control software would automatically pilot said aircraft safely away from said prohibited area if the magnitude of said perpendicular velocity component became large enough to ensure that said aircraft could not safely avoid said prohibited area.

10. The control system of claim 1, wherein said override control computer can only be engaged after a violation of a prohibited area has been confirmed by a third party not aboard the aircraft.

11. The control system of claim 1, wherein said override control computer disengages all manual flight controls available to the pilot.

12. The control system of claim 1, wherein said notification system can play a recorded message via an intercom to passengers to inform said passengers that said aircraft has attempted to enter a prohibited area or is undertaking erratic maneuvers, at the discretion of the air traffic controller or other authority.
